(19) United States
(12) Patent Application Publication
(10) Pub. No.: US 2005/0273200 A1
(43) Pub. Date: Dec. 8, 2005

(54) Process for protecting a robot from collisions

(76) Inventors: Gerhard Hietmann, Herbertshofen (DE); Martin Weiss, Margertshausen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/147,100

(22) Filed: Jun. 7, 2005

(30) Foreign Application Priority Data
Jun. 8, 2004 (DE) 10 2004 027 944.6

(51) Int. Cl. G06F 19/00

(52) U.S. Cl. 700/248; 700/245

(57) ABSTRACT

A process for protecting at least two robots is provided, especially multiaxial industrial robots, from collisions, in which movements of a robot are automatically checked for possible collisions. Interlocks are automatically inserted in the movement process.

### CROSS REFERENCE TO RELATED APPLICATIONS

This application claims the benefit of priority under 35 U.S.C. §119 of German Application DE 10 2004 027944.6 filed Jun. 8, 2004, the entire contents of which are incorporated herein by reference.

### FIELD OF THE INVENTION

The present invention pertains to a process for protecting at least one robot, especially at least one multiaxial industrial robot, from collisions.

### BACKGROUND OF THE INVENTION

Asynchronous movement processes of the robots and other mobile objects due to non-synchronized feed and removal of materials (insertion station, shuttle, intermediate buffering filling level, different machining times, etc.) are not avoidable within a production cell and they are mostly optimal concerning the machining time. To comply with preset joining sequences, processes also must, moreover, be carried out sequentially. If an application or a process requires machining by a plurality of robots, auxiliary axes or transport systems in a crowded area in space or in a working area used jointly, robots may cross paths of movements of objects. This will then lead to a collision and to damage to the robot, flange tool, transport system or other peripheral components.

Corresponding mechanisms for avoiding collisions must be embodied to prevent this. This is done at present in such a way that common working areas or movement aisles are utilized staggered in time. Which robot, which auxiliary axis or which transport system is present in the working area or space area used jointly at which time and in what sequence is now set by the user by interlock statements in the robot program. The interlock information is communicated either via digital inputs/outputs, which information each robot control exchanges with a central memory-programmable control (PMC). The working areas are organized on the PMC. The exchange of interlock information via a bus system below the participating robot controls without the integration of a PMC is known as well. The working areas are managed here on one or more robot controls. No blocked or working areas are defined in space in this type of interlock, but communication takes place via a signal only, or it is checked whether the robot has run through a certain point in the program. However, it is the responsibility of the programmer alone that no collision occurs in the process.

Interlocks correspond to the semaphore mechanism for protecting critical areas, e.g., resources being used jointly, which is known from information technology. Distinction is made between digital semaphores for the exclusive protection of critical areas or counting semaphores (e.g., Edsger W. Dijkstra, 1965: Solution of a problem in concurrent programming control, Communications of the ACM, Vol. 8, No. 9). Only binary semaphores are used in this invention, because working areas of robots are used exclusively. Binary semaphores correspond to “guarded” binary variables, which indicate whether the critical area is occupied. A mechanism of the operating system or of the robot control guarantees that only one process can come into possession of the semaphores at any time.

Implantations are encountered in all real-time operating systems, such as vxWorks or even in robot controls, as according to EP 1 336 909 A2, whose disclosure is made entirely the disclosure content of the present application. The additional problem that the semaphore access takes place via data lines arises in distributed systems, such as robot controls.

In many applications of robotics and automation technology, the access to a critical area is signaled by setting a binary output on a bus system. Each participant must check before the use of the critical area whether this variable has been set. However, this fails to offer the security offered by semaphores, because the two operations “checking whether a variable has been set and optionally setting it” can usually be interrupted.

If a robot reaches an area in which there is a risk for collision, such as an area used jointly by two robots, it checks by means of an “EnterSpace” statement provided in the program whether the working area is free. If it is free, the robot can enter the working area. If it leaves this area, it releases the area via an “ExitSpace” command. If the area is not free, the robot must wait until the robot occupying the area has released this area in the manner outlined above.

Since a plurality of robots work in a very crowded space in many cases and the movements take place in a non-synchronized manner, it is not obvious to the user which of the robots can collide with which other robot. There is a possibility of collision not only with the robot hand or the tool being carried by the robot. All moving parts can collide with other objects in the machining cell. This may be the entire mechanical structure in the case of the robot. Furthermore, the tool, the part that is being carried by the tool, transport systems, auxiliary axis kinematics, part clamping devices, protective fences, colunms, tables or the like are affected.

If the programmer forgets about an interlock, deletes it by mistake or disregards it in another way, this may lead to a collision. Costly disturbances may thus arise especially during the phase of start-up of a production cell/plant. However, unrecognized collision potentials also lead to collisions in a non-producing plant because of the asynchronous movement process when a critical constellation accidentally develops for the first time and the necessary interlock is missing.

The following problems are to be mentioned in connection with the on-line collision recognition: Since a stop is prompted in the robots when a possible collision is recognized, and the mobile parts of the robot have a velocity- or load-dependent brake path, a prospective check for collisions taking the brake path into account must be performed. This is not always simple in practice. On the one hand, this prospective view cannot be embodied in a robot system in a simple manner, and the brake path, which depends on the kinetic energy, does not allow a constant prospective path, either. On the other hand, a real time-capable collision monitoring of a plurality of complex objects can hardly be achieved for reasons related to real time and memory reasons. The main drawback is, however, that collision potentials are recognized only when a possible collision occurs and this leads to stopping of the robot. The production is thus interrupted and the user must modify the program during the production operation and program corresponding interlocks.

Another known approach is the “on-line collision-free” path planning. When a collision potential is recognized here, attempts are made to change the movements of the robots such that the robots can move past each other without collision. Besides the problem of the above-described prospective approach and the real time capability, which likewise apply now, the requirements are not met satisfactorily in case of working areas used jointly. It is necessary in such applications that, e.g., a robot first accomplishes its task at a part before the machining with the other robot can take place. The automatic planning of a collision-free path cannot lead to a satisfactory solution here. The user's knowledge about the correct/optimal stop of the waiting robot and the knowledge about the sequence of machining by the robots in the joint working area cannot be satisfactorily implemented now because of the given complexity.

The generation of optimal collision-free paths that is suitable for practice and the automatic setting of optimal stops and movement sequences (sequence of the use of common working areas) is therefore still impossible now in case of complex machining cells with robots and transfer systems.

### SUMMARY OF THE INVENTION

The basic object of the present invention is to provide a process with which at least one robot can be reliably protected from collisions especially with other robots.

The object is accomplished according to the present invention in a process of the type mentioned in the introduction by automatically checking movements of the at least one robot for possible collisions and by automatically inserting interlocks in the movement path and by giving instructions to the user for interlocks to be inserted.

Consequently, the present invention contains an off-line analysis of the participating robot programs on the basis of which the robot programs are modified, if necessary, by inserting interlocks. The check for collisions—for programming sentences—takes place for sentences (“unit operating commands”) off-line, i.e., before the start of the robot programs for all possible combinations of sentences on the participating robots. Consequently, points in the program or sentence numbers at which interlock statements are to be inserted into the program are determined according to the present invention. This off-line processing may contain models with a high degree of detail, because no real time requirement is imposed on this processing step. Internal intermediate results of this check for collisions can be stored within the framework of the present invention, as a result of which it is possible, e.g., reteach only a few points, for which little computation time is needed. The result of the check for collisions is inserted in the program via interlock statements, i.e., the programs are expanded. Checking for “waiting necessary” is not coupled to movement commands, but is an independent statement of the robot program. However, cycle time is gained as a decisive advantage due to the finer check for collisions.

Consequently, a check for collisions is performed according to the present invention before the start of the robot programs and interlock statements (semaphores) may be inserted, if necessary, which are implemented to the exchange of binary values during the run time. No geometric information is exchanged; the geometric processing took place rather off-line and was concentrated into binary variables. The result is collision-free programs that are able to run, which make do without on-line collision recognition.

The following is therefore essential for the present invention:

1. Robot programs are checked for collision potentials before they are executed.

2. Only binary values are exchanged between the robot controls via the interlocking mechanism in the manner of semaphores. There is no exchange of geometric information on the working area or the working space occupied by the robot.

3. Interlocks are separate program statements independently from movement commands. Interlock commands trigger communication between the participating controls for the exchange of semaphore variables. However, there is no implicit communication in case of movement commands according to the present invention for exchanging geometric information, i.e., there is no time delay in movement commands.

4. No check for collisions is performed during the run time of the robot programs.

It is avoided by the process according to the present invention that necessary interlocks are forgotten. Moreover, the process according to the present invention creates the requirements for avoiding superfluous interlocks. The process according to the present invention operates off-line. Instead of the automatic entry of the interlocks in the programs, a corresponding suggestion can also be given, as an alternative, to the operator by the process.

According to a preferred embodiment of the process according to the present invention, the present invention makes provisions for determining permissible interlock points before the insertion of an interlock, preferably before the checking for possible collisions, as a result of which the interlocked areas may reach any desired length, regardless of movement commands in the program text. This can be achieved in a preferred embodiment of the process according to the present invention by determining sentence limits as possible interlock points.

A “sentence” is a program section of minimal length between two possible interlocks here. Sentence limits are the limits of such a sentence. These can be determined, for example, by the robot stopping at them, i.e., it is located at an exact stop. It is also possible, e.g., by path switching functions (also referred to as triggers at KUKARoboter GmbH), interlocks on the path, i.e., not necessarily at an exact stop. However, the activation or deactivation of the interlock is possible only with the resolution of the interpolation cycle in this case as well. Sentence limits are possible in this case at the discrete positions that are obtained during the scanning of the path with the interpolation cycle of the particular control and 100% velocity. Furthermore, it is possible to preset values via a Cartesian or axis-specific distance that must be present as a minimum between two interlocks. As a result, an “incrementation control” is possible for the interlock. An interlock point may also be provided in each interpolation cycle in the extreme case. The term “interpolation” is defined in robotics as the discrete scanning of a (velocity) profile or a path (in space), contrary to the usual definition employed in mathematics.

According to another preferred embodiment of the process, provisions are made that bounding volumes of the at least one robot or robot parts, which are checked for collisions, are generated for the collision recognition, and the hierarchies of such bounding volumes, which can be generated especially with any desired high degree of detail, are generated in the known manner in a preferred variant. A hierarchy of bounding volumes is used to reduce the average effort for a collision check between two objects. The hierarchy comprises here simply structured bodies, which surround the entire geometry of the original object, and even the convex volume of that object. The bounding volumes can be transformed, on average, more rapidly to the current position and checked for collision than the exact geometry of the corresponding objects. The use of bounding objects to rapidly rule out collisions is a suitable method of approximately achieving real time capability. Possible bounding volumes are spheres, axis-oriented boxes (AABB), oriented boxes (OBB) and convex volumes as well as optionally additional geometric bounding volumes. The bounding volumes are generated mostly off-line and are arranged in an ascending order according to their accuracy of approximation. An exception is AABBs, which is generated by the system anew after each movement of the object on the basis of a “local” OBB. The ratio of the volume of the bounding volume to the volume of the underlying object is used as the heuristics for the degree of approximation. If different types of bounding volumes have a similar degree of approximation, the bounding volumes with the more time-consuming collision check are discarded. The topmost level of the hierarchy and consequently the most accurate representation of an object is formed by the convex volume of the object. Various program packages can be used for the collision recognition and for calculating the distance between convex volumes. As long as the bounding volumes of the two objects collide, the hierarchies are run through up to the checking of the convex volumes against one another. If these intersect as well, the collision recognition sends back “collide.”

Provisions are made in an alternative preferred embodiment for determining the intersection of the points of both volumes of the bounding volumes thus generated for at least one robot with the bounding volume of another object, which may likewise be a robot, the bounding volume of the other object being determined correspondingly, or for determining the mean distance between two bounding volumes.

Provisions may be made according to an extremely preferred embodiment of the present invention for the working space of the at least one robot as well as of another moving object, which may likewise be a robot, to be divided into disjunct partial volumes and for entering for each partial volume in a corresponding table the sentences for which the at least one robot and the additional object occupy the particular partial volume. The disjunct partial volumes may be disjunct cubes in a preferred embodiment.

Another preferred embodiment of the process according to the present invention provides for merging consecutive determined interlocks with one another in order to keep the number of interlocks low and to reduce the communication effort as a result.

Other preferred embodiments of the present invention appear from the claims or from the following description, in which an exemplary embodiment of the present invention will be explained specifically with reference to the drawings.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic top view showing a robot cell with three robots;

FIG. 2 is a diagram showing the course of movements of two robots with interlocks;

FIG. 3 is a flow chart for the entire process according to the present invention;

FIG. 4 is a schematic view of robot programs with sentence structure and collision risks;

FIG. 5 is a view corresponding to that in FIG. 4 with semaphores and possibilities for merging; and

FIG. 6 is a graphical view showing an example for expanding a subroutine.

### DESCRIPTION OF THE PREFERRED EMBODIMENTS

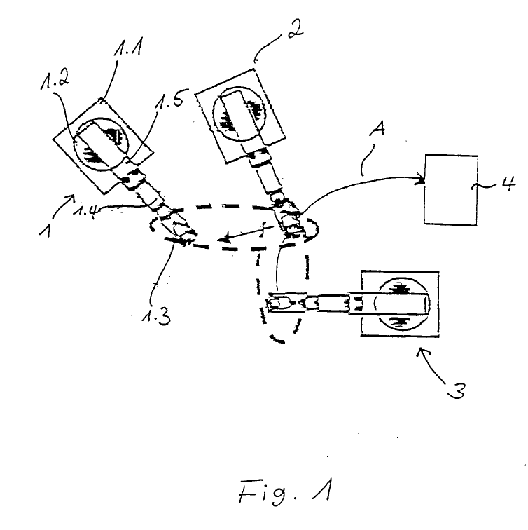

Referring to the drawings in particular, FIG. 1 shows a robot cell with three cooperating robots 1, 2, 3. The individual parts socket 1.1, carrousel 1.2, rocker 1.3, robot arm 1.4 and robot hand with tool 1.5 are designated in robot 1. The other robots 2, 3 have a corresponding design. The robots are arranged such and operate such that there are collision areas, which are schematically indicated by broken lines in FIG. 1. For example, a collision would occur between robot 3 and robot 2 in the shown position of robot 2 if robot 3 moved from its position, which is likewise shown, into the position shown for depositing a part 4 corresponding to arrow A.

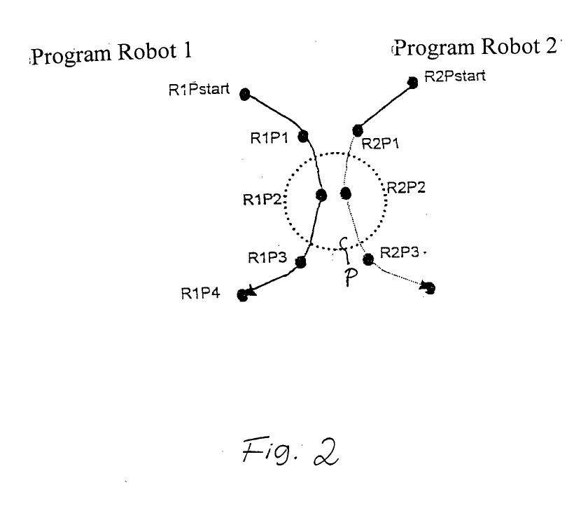

To prevent such a collision, interlocks are set and released, as they are shown in FIG. 2.

A working area used jointly, in which a collision could occur, is indicated by dotted lines here. For example, a robot 1 starts from its starting point R1Pstart and moves to a point R1P1 before the collision area P. By means of an “EnterSpace” statement provided at this point in this control program, it checks whether the working area P, in which the next target R1P2 is located, is free. If it is free, the robot 1 can enter the working area. If the robot 2 later reaches its entry point R2P1 in the common working area P, it will likewise execute the “EnterSpace” statement, but it will receive a signal that the area is occupied by the robot 1 because the robot 1 has already entered the working area P, so that the robot 2 must wait until R1 releases the area. This happens after the robot 1 has left the working area P at point R1P3 due to the “ExitSpace” command sent by this robot, and the “EnterSpace” statement may possibly trigger a true-to-path stop, i.e., there will be no collision due to leaving the path even during a stop.

According to the present invention, the programs are distributed among a plurality of program controls. An additional computer is used as a central computer for the process (it is possible that one of the robot controls is used as the central computer). The computers are connected to a network. A first expression of the present invention provides for all programs of all robots to be processed on the robot controls (possibly in a “dry run,” in which the real axes do not move). The paths generated are interpolated at certain time intervals, the increment of the interpolation being possibly able to be set by the user. Bounding volumes are generated for the robot configuration at each interpolation point on the basis of the current axis angles and CAD data (this step is possible on both the robot controls and the central computer). The bounding volumes are stored in the central computer. A second expression of the present invention makes provisions for the control computer copying, via network connections, all programs of all robot controls, as well as bounding volumes for the robots, auxiliary axes and all peripheral components used (tools, workpieces) from the robot controls in the local memory and for interpreting the programs in a dry run. CAD data are already available in the central computer. Bounding volumes are prepared for all points in time analogously to the first expression.

The data management and check for collisions may be run either distributed among the robot controls or on a computer used specifically for this purpose. All the information that is necessary for updating the cell model (current robot axis positions, position of the transport systems, dimensions of tools and parts, etc.) must, of course, be communicated to the point at which they are needed for updating the cell model and for the collision calculations. The present invention makes provisions both for the expression

that all programs are generated from CAD/CAM data off-line, and interlocks are inserted according to the process according to the present invention before the programs are run on the robot unit for the first time,

and (for the expression) that programs are either taught or generated off-line, then transferred to the unit, and the interlocks are then inserted in the unit according to the process according to the present invention (using the computers present in the controls). “Off-line collision avoidance” in this sense means that the interlocks are inserted independently from and chronologically prior to the actual run of the unit.

“Off-line collision avoidance” consequently means that no information on geometric models must be present in the controls for collision avoidance during the actual running of the program of the robots. Such information was used before, i.e., “off-line,” in order to determine and enter the interlocks.

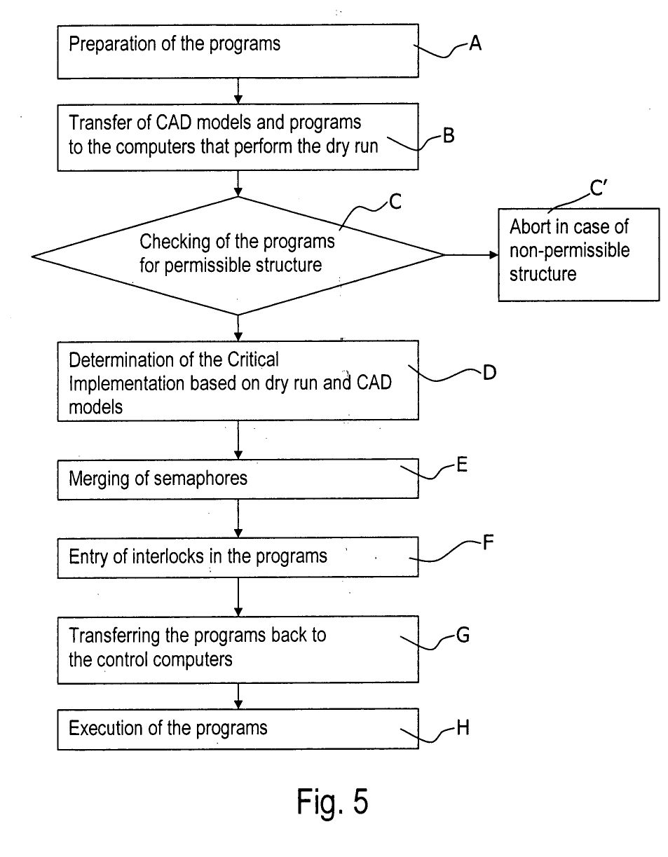

The process according to the present invention is consequently based on the fact that control programs are first prepared for the robot or robots according to FIG. 5 (Step A). Like the bounding volumes of the robots, these control programs are transferred onto computers, by means of which a “dry run,” i.e., the programs are run without the robots being actually moved (Step B).

The programs are first checked for a permissible structure (Step C); if there is no permissible structure, there is an abortion (Step C′). In case of a permissible structure, the critical implementation is determined on the basis of the said “dry run” and the CAD models intended (Step D).

Semaphores are merged (Step E).

Automatic interlocks are then entered in the programs (Step F), and there is no joint interlock for two sentences (S(i, 1) and S(i+1, 1)) if these are protected in the program of robot 1 by interlocks against the presence of robot 2 in the same areas. The programs are then possibly transferred back into the control computers proper (Step G), where the programs can then be executed (Step H).

The process according to the present invention for setting and releasing interlocks in control programs for robots takes place specifically as follows:

The points in the program are analyzed and program points at which interlocks can be inserted in the program are identified. These are restricted by the movement commands only, while other program commands, such as computation operations, job assignments, etc., are not relevant for the process. It is first checked whether all points in the programs are preset as fixed points rather than being calculated by a computation instruction during the program run, e.g., on the basis of external signal; whether any movements take place that indirectly use external signals, such as sensor-guided movements, because the path of movement is not fixed in this case, and whether any branching movements are permitted at any desired points of the path, for example, on the basis of interrupt statements. It is not possible to carry out the process described in these cases.

R robots are taken into consideration; they are designated by r=1 . . . R. Either a program P(r) with a duration T(r) runs (cyclically) or one of L(r) programs P(l, r), in which l=1, . . . , L(r) with the duration T(1, r) runs randomly one after another on each robot, It is assumed in this case that at the end of each program, all robots move into a defined starting position, which is consequently automatically the starting point for all programs, If not, new programs can be defined for each program, and these programs will run at all starting points of the other programs, and the process can be based on this expanded set of programs.

If synchronization points are possible at fixed points only, the areas between the possible synchronization points are designated in the manner already outlined above as sentences S(i, r) in which i<1, . . . , M(r), in which M(r) is the number of sentences of programs P®).

The path of program P(r) is evaluated at N(r) points in time t(1, r)<t(2, r)< . . . <t(N (r), r), and the corresponding volume (V(i, r)⊂R³ occupied by the robot is determined for the axis configuration valid at the point in time t(i, r) and the active tool on the basis of the CAD models. The time intervals are not necessarily fixed, and scanning on the basis of traveled Cartesian or axis-specific paths may also be possible. The path is scanned in case of such an “incrementation control” such that no axis or Cartesian component or orientation component will have traveled more than a specifiable path between two points in time.

Indices, which correspond to points in time, can always be considered to be modulo of the corresponding number of points in cyclic programs: Equality of indices i=j always modulo N(r) shall apply for robots r with N(r) restart points, i.e., for example, N(r)+1=1 is identified as equivalent. This corresponds to the obvious fact that in case of a cyclic program run, the synchronization points introduced by the process depend on the geometric path only and are therefore always the same, regardless of which point of the path is selected as the starting point 1 for the process. For programs with control structures, the cyclic successor relation is to be replaced by quantile follower descriptions. The notations commonly used in the set theory and predicate logic are otherwise used.

After checking the programs, sentence limits are introduced. In case of a linear program flow structure, in which all programs consist of a sequence of movements that are run through cyclically or once, commands can be identified, e.g., by a number, and the preceding or next command can be determined for each command in a simple manner (addition or subtraction of 1). A set of possible successors is potentially obtained with control structures (instead of the operation “+1” all elements of a successor set must be taken into consideration).

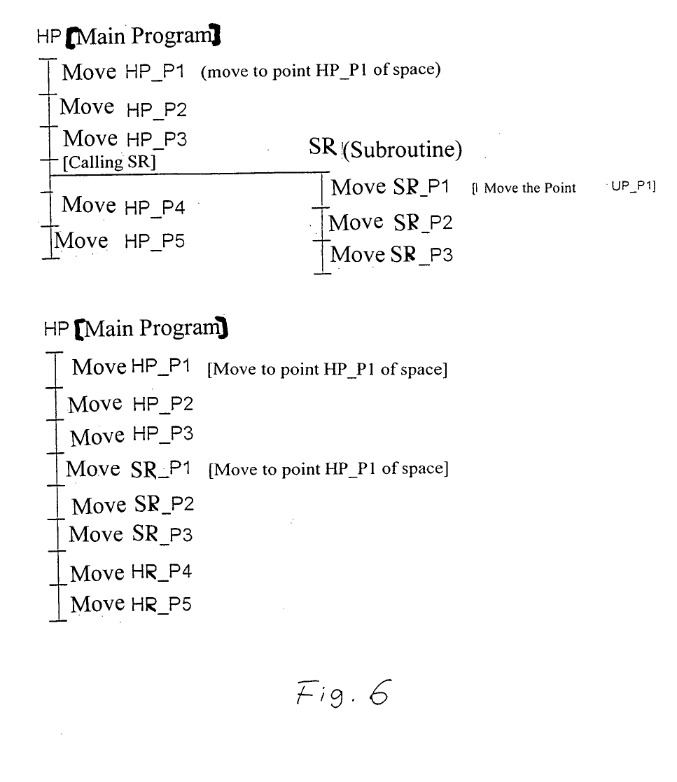

Subroutine invocations, branchings and loops may be used in programs according to the state of the art. These can be shown in a general graph (as a special case in linear/cyclic programs: cycle of commands), which reflects the program structure. Even though the notation of the algorithms being described here is more complicated now, it is basically identical. As an alternative, it is possible to treat, e.g., subroutine invocations with the process being described here by expanding the commands of each subroutine SR to the location of the invocation, as this is illustrated in FIG. 6.

| Original | Expanded |
|---|---|
| PTP 1 | PTP 1 |
| PTP 2 | PTP 2 |
| UP 1 | PTP U1 |
| | LIN U11 |
| PTP 3 | PTP 3 |
| PTP 4 | PTP 4 |
| UP 1 | PTP U1 |
| | LIN U11 |
| UP 2 | PTP U2 |
| | PTP U3 |
| PTP 5 | PTP 5 |

in which SR means subroutine, PTP a point-to-point movement to the particular point indicated next to it, and LIN designates a linear movement. An abbreviation for the original programs is shown in the first column, and an abbreviation of possibly expanded programs, which form the content of the subroutines within the framework of the expansion, is shown in the second column.

Sentence limits are entered after reduction to this “normal form.” As was explained above, these limits limit the movement sections of minimal length, which can be protected by the interlocks. It is permissible, in principle, to set an interlock in each interpolation cycle or even at each continuous point in time. However, a finite number of points must be set in case of continuously displaceable interlocks in order to guarantee that the process will be carried out. As an alternative, a desired discretization step can be stated, within which interlocks shall be sets.

The check for collisions will then be performed. Collision checking processes typically use bounding volumes of the geometry of robots, tools, workpieces, sensors and other objects commonly used in automation. The bounding volumes for checks for collisions depend not only on the joint variables of the robot, but also on the particular tool and workpiece used; for example, a gripper occupies a different volume of space depending on the workpiece being grasped in the particular case. Devices for automatically changing a plurality of electrode holders, grippers, etc., are known as well. It is assumed in the present invention that it is known at any point in time during the program which tools, etc., are active, and that the corresponding CAD data are available in a suitable form.

The following properties of intersection processes are essential for the present invention: It can be decided whether a collision is possible for two sentences each (i.e., program sections of different robots) and for bounding volumes given for each point in time of these sentences. The result of this checking is a binary variable. For example, the two processes described below can be used for this check.

Additional designations are necessary to describe the processes: The result of the collision checking is information to be called a “critical implementation” C(i, j). This will be described below for the case R=2 only, i.e., for only two robots. An expansion to R>2 robots is possible without problems. The following applies:

C: {1, . . . , M(1)}×{1, . . . , M(2)}→{TRUE, FALSE}

C(i, j):=TRUE if there is a risk of collision during the simultaneous operation or robot 1 in sentence i (of P(1)) and of robot 2 in sentence j (of P(2)), otherwise, C(i, j):=FALSE.

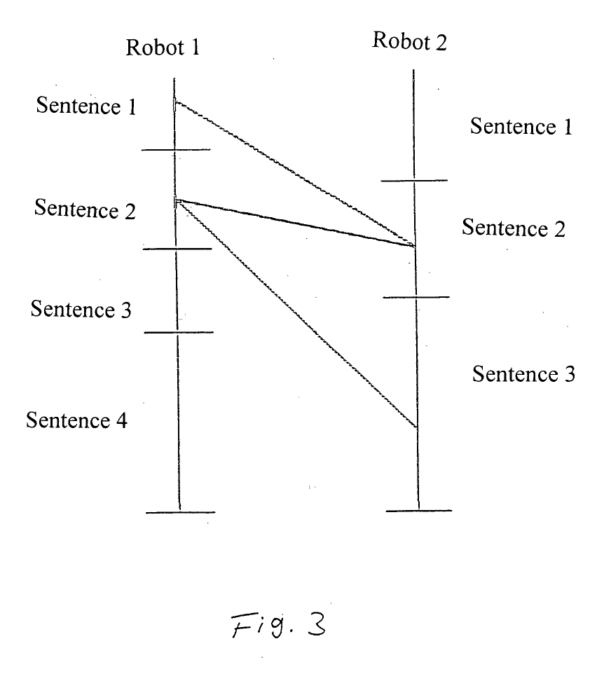

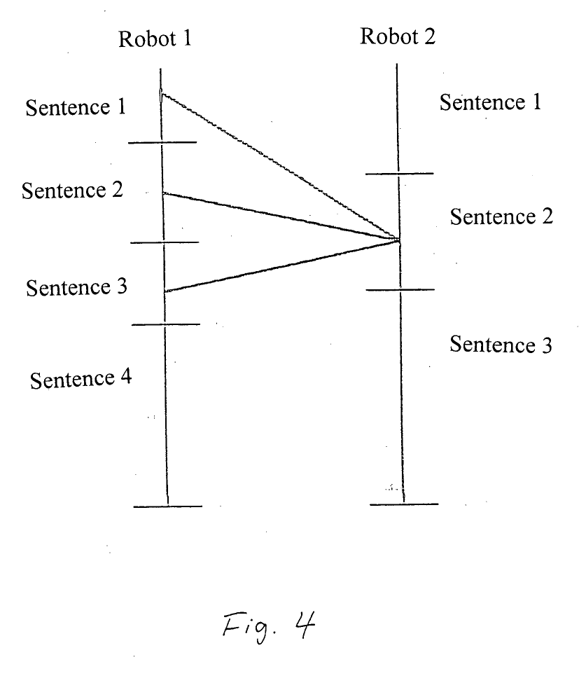

The sentences in the two robot programs can be plotted as numbered sections of a straight line, as is shown in FIG. 3 and FIG. 4. The length of the sections is not relevant, but it can be used to additionally illustrate the duration or the path traveled for a sentence. A connection is drawn between sentences i and j of the two robots 1, 2 if C(i, j)=TRUE, i.e., if there is a risk of collision.

If robot 1 is working in sentence 1 and sentence 2, robot 2 cannot enter after sentence 2 in the example shown in FIG. 3. As soon as robot 2 has left sentence 1 (and reached sentence 3), robot 2 can enter sentence 2, but not after sentence 3.

As was hinted at above, the check for collisions can be performed according to the present invention based on the determination of the intersection of general sets or on the basis of the breakdown of the work space of all robots into digital subsets, especially the “cubes.” The first process will be explained first.

The algorithm A for determining the intersection of two volumes V and W (volume designates subsets of the Cartesian space, which are always limited, closed and without voids, in the mathematical sense of the algebraic topology, which exactly correspond to the view here) can yield as the result either a boolean variable

A(V,W)=TRUE if V and W intersect; otherwise FALSE;

or the minimum distance of the volumes d(V, W)=min {d(v, w):v∈V, w∈W} (Hausdorff distance). V and W will intersect exactly (for closed and limited sets) when d(V, W)=0. The following definition can then be made for the process according to the present invention

A(V, W)=(d(V, W)==0)

The information d(V, W)>0 can now be used for more efficient implementations of the process: If d(V, W) is very high, this means that the robots must first move for a certain time to reach a critical distance at all. Using the known maximum velocities of the robots, the calculation of some steps can be omitted in this case, and “no intersection” can be assumed. The fact that the volumes will not differ greatly from one time step to the next will be used, in principle, for efficient implementation. Concrete implementations of such processes use a breakdown of the robot and component structures into convex sets or enveloping curves, typical ellipsoids, which are arranged in a tree-like pattern. Rapid intersection checks can be performed for such data structures:

C(i, j)=V{A(V(t(i, 1)), V(t(j, 2))): t(i, 1)∈S(i, 1), t(j, 2)∈S(j, 2)}

In words: Sentences i (of robot 1) and j (of robot 2) are critical in terms of collision if the volumes of at least one point in time t(i, 1) in sentence i and of at least one point in time t(j, 2) in sentence j intersect.

The critical implementation can be equivalently defined by:

C(i, j)=((u{V(t(i, 1)): t(i, 1)∈S(i, 1)})∩

(∪{V(t(j, 2)): t(j, 2)∈S(j, 2)}))Ø

However, this operation is usually difficult to carry out, because many structural properties, which are used for algorithms for checks for collisions, are lost when the union of sets ∪(V(t(i, 1)): t(i, 1)∈S(i, 1) is formed (hierarchy, convexity of enveloping sets, spheres or other simple geometric objects as enveloping surfaces). In brief, the algorithm A yields the intersection information for points in time, which correspond to individual configurations of the robot. The critical implementation yields the same information for periods of time, which correspond to paths.

In the worst case, each robot volume must be checked for collision during the check for collisions at any point in time against each other robot volume at all other points in time: This requires O(N(1)x . . . x N(R)) operations (in the sense of the complexity theory). This represents a time-consuming operation, even if this check must be performed only once.

The preferred expression of the present invention therefore provides for the following, usually more rapid process: The entire working space of all robots is divided into cubes W(1), . . . , W(z) (as an alternative and without limitation of the process, a breakdown into disjunct subsets). The fineness of the collision recognition can be set by selecting the side length of the cubes. A table, which shows the sentences for which each robot occupies this cube, is assigned to each cube W(z) for each robot. This can be done, e.g., in the following ways:

1. A boolean variable D1(z, r, s) with the value TRUE if the cube W(z) is occupied by the robot r at any point in time of sentence s.

2. A quantile variable D2(z, r), in which all sentences of the program of robot r are entered, which occupy the cube W(z) at any point in time.

D1 and D2 are determined algorithmically in the following manner:

1. Initialize D1(z, r, s)=FALSE or D2(z, r)=Ø for all z, r, s

2. For all robots r

3. For all sentences s in the program P(r) of robot r

4. For all points in time t(i, r) in sentence s

5. For all cubes W(z)

6. Determine the intersection of W(z) with V(t(i, r) r). If this is not empty, write D1(z, r, s)=TRUE or add s to D2(z, r).

The determination of the critical implementation C from D1 or D2 is then performed in the following manner:
If R=2, i.e., 2 robots:

$$1. C ( i , j ) = {{⋁}^{z}}_{z = 1} ( D1 ( z , 1 , i ) \hat{} D1 ( z , 2 , j ) )$$

(i.e., =TRUE if robot 1 in sentence 1 and robot 2 in sentence j occupy at least one cube z at the same time; if not, FALSE)
2. C(i, j)=∃_{z}:(i∈D2(z, 1))\hat{ }(j∈D2(z, 2)) (i.e., TRUE if for a cube z robot 1 in sentence i and robot 2 in sentence j occupy this cube at the same time; if not, FALSE).
   This preferred process for determining the critical implementation C requires only O(N(1)+ . . . +N(R)) operations compared to the above-mentioned O(N(01)x . . . x N(R)).

The process requires some effort in terms of memory, but this can be considered to be inexpensive, whereas time is, in principle, a commodity in short supply. The data on collisions can also be stored in an external memory and used for the rapid determination of the semaphores if the programs have changed only slightly.

The determination of the necessary interlocks is determined after the check for collisions. Usual robot controls have, as a rule, a concept for distributed semaphores. These can be embodied, among other things, with the use of binary inputs and outputs.

Each pair of semaphore statement brackets EnterSpace (SemaphoreIdentifier) and ExitSpace (SemaphoreIdentifier) on two robots can be considered to be a logic interlock of the statements between the statement brackets, and thus an interlock of the working areas, which the robots use during the processing of the commands between the brackets. Typical embodiments of semaphores use inputs and outputs, which can be accessed from other controls.

The simplest procedure for avoiding collisions is to protect all sentences i on robot 1 and all sentences j on robot 2, for which C(i, j)=TRUE, in the following manner:

Define semaphores (with the same name for simplicity's sake C(i, j) for all i, j for which C(i, j)=TRUE. This means a maximum of M(1)*M(2) semaphores.

Interlocks are then preferably, but not necessarily, merged, in order to keep the number of semaphores (FIG. 5, Step E) as low as possible (FIG. 3, E). The following algorithm yields the minimum number of semaphores:
1. Repeat
2. if C(i, k)=C(i+1, k) for all k, then merge the sentences S(i, 1) and S(i+1, 1) into a sentence with only one interlock, which will then have the same properties concerning the collisions with sentences of robot 2. Instead of the semaphores C(i, k) and C(i, k+1), use only one semaphore C(i, k), which has the same name for simplicity's sake. The semaphores C(i, k+1) can be spared.
3. if C(k, j)=C(k, j+1) for all k, then merge sentences S(j, 2) and S(j+1, 2), which will then have the same properties concerning the collisions with sentences of robot 1. Analogously to point 2, the semaphore C(i, k+1) can be spared.
4. As long as there are indices i and j with properties 2 or 3.

It can be shown that any other merging strategy will needlessly limit the mutual freedom of movement of the robots. In the example according to FIG. 4, the semaphores C(1, 2), C(2, 2), C(3, 2) can be reduced into one semaphore. If C(k, j) =C(k, j+1) not for all k, then it is not possible to merge sentences S(j, 2) and S(j+1, 2).

The semaphores S(2, 2) and S(2, 3) cannot be merged in FIG. 3, because they differ from robot 1, e.g., in respect to sentence 1. The merging of S(2, 2) and S(2, 3) would then also prohibit the simultaneous operation of robot 1 in sentence 1 and of robot 2 in sentence 3. The merging of semaphores and sentences under weaker conditions needlessly limits the movements. Deletion of semaphores obviously generates programs with potential collisions. If branchings and loops are also considered in an expansion of the present invention instead of linear and cyclic programs, additional <do not merge> marks are needed, e.g., at the limits of alternatives.

Program statements for interlocks are subsequently entered (FIG. 5, Step F).

A pair of EnterSpace, ExitSpace is entered for each interlock C(i, j) in each participating program around the sentence to be protected. A typical program pair will then have the following form:

Program for Robot 1:

. . .

S(i−2, 1)

S(i−1, 1)

EnterSpace (C(i, j))

S(i, 1)

ExitSpace (C(i, j)

S(i+1, 1)

S(i+2, 1)

. . .

Program for Robot 2:

. . .

S(j−2, 2)

S(j−1, 2)

EnterSpace (C(i, j))

S(j, 2)]

ExitSpace (C(i, j))

S(j+1, 2)

S(j+2, 2)

. . .

If interlocks are also possible within movements, e.g., at each IPO cycle, time-related constructs are necessary, e.g., so-called trigger statements in the KRD language:

. . .

S(i−2, 1)

S(i−1, 1)

Trigger Delay=x1 msec do EnterSpace (C(i, j))

Trigger Delay=x2 msec do ExitSpace (C(i, j))

S(i, 1)

S(i+1, 1)

S(i+2, 1)

. . .

After entering all interlocks and optionally after transferring the programs back to the control computer, the programs can be run. All robots are moved for this purpose into a preferred position (also start position of the programs), in which there is no risk for collision, and all interlocks are abolished. If a robot program P(i) reaches an EnterSpace (S) interlock, whose semaphore was not taken by any other program P(j), P(i) takes the semaphores to S and can move the robot into the protected area without a stop. If P(i) reaches the command for abolishing the ExitSpace (S) interlock, the semaphore to S is released and the protected area will be left. If a robot program P(i) reaches an EnterSpace (S) interlock, whose semaphore was taken by another program P(j), there will be a stop for program P(i) because of a risk for collision. If the interlock is then released in program P(j) by ExitSpace(S), the running of program P(i) can be continued. If the robots are moved manually (e.g., at start-up, after a stop, etc.), the user must explicitly manage the interlocks/semaphores via the operating unit.

Interlocks are already set by the programmer during the programming and start-up of robot units. Experience has shown that this is extremely prone to errors. The process described so far for determining interlocks in programs without an interlock can be modified as follows in order to check existing interlocks for completeness and to complement them if necessary.

1. The existing programs are analyzed and the assignment of sentences and interlocks is determined. The existing interlocks are interpreted as a critical implementation K(i, j): K(i, j)=TRUE exactly when sentence i of robot 1 and sentence j of robot 2 cannot pass through simultaneously because of existing interlocks. (The argument is consequently inverse in some way to the determination of the interlocks: C(i, i)=TRUE applied there if there was a risk for collision, and the interlocks were set correspondingly. Here, K(i, j) is determined from existing interlocks.)

2. Carrying out the process of determining interlocks. The result is a minimum set of necessary interlocks, defined on the basis of the critical implementation C(i, j).

3. If K(i, j)=TRUE for all i, j for which C(i, j)=TRUE, the interlocks already programmed are sufficient. (K(i, j)=TRUE, but C(i, j)=FALSE corresponds to an unnecessary interlock, which does not, however, jeopardize safety).

4. If K(i, j)=FALSE for an i, j, for which C(i, j)=TRUE, there is a risk for collision. As an alternative, a message is sent, which prompts the user to program an interlock (and, if not, prevents the program from starting), or an interlock is automatically inserted for C(i, j).

It is necessary from time to time to change programmed points in plants during operation because feed means, tools or other peripheral means may have undergone mechanical changes (wear, damage, aging). However, only a few points and a few sentences are usually affected, often on an individual robot only. New possibilities of collision will now potentially arise, which were not present before the reprogramming. The interlocks shall be determined as quickly as possible for reasons of time. If the interlocks on this robot have now been determined with the process described on [original] pages 18 through 20, it can be determined in an especially advantageous manner how the interlocks must be changed on all robots. It is assumed for this that the variables D1(z, r, s) and D2(z, r) were stored in an external memory. Furthermore, the present invention assumes that it is known based on a variable for each sentence and point whether this sentence or point has been changed since the process for determining interlocks was carried out last. Of the information D1, D2, only those that pertain to changed sentences must be recalculated by the (relatively) time-consuming geometric intersection checking with cubes. All old interlocks are then removed from the programs and new interlocks are entered on the basis of the new information D1, D2.

While specific embodiments of the invention have been shown and described in detail to illustrate the application of the principles of the invention, it will be understood that the invention may be embodied otherwise without departing from such principles.

1. A process for protecting at least one robot, from collision, the process comprising the steps:
checking the movements of the at least one robot automatically checked for possible collisions; and
determining if interlocks are necessary and if so automatically inserting interlocks in the movement process.

2. A process in accordance with claim 1, wherein program movements of the at least one robot are automatically checked for possible collisions before the program is carried out, and that interlock statements are automatically inserted into the program text generating the movement process.

3. A process in accordance with claim 1, wherein permissible interlock points are automatically determined before an interlock is inserted or before the check for possible collisions is carried out.

4. A process in accordance with claim 3, wherein sentence limits are determined as possible interlock points.

5. A process in accordance with claim 1, wherein bounding volumes of the robots or robot parts, which are checked for collisions, are generated for determining collisions.

6. A process in accordance with claim 5, wherein hierarchies of bounding volumes are generated.

7. A process in accordance with claim 1, wherein the intersection of the bounding volumes of at least two robots is determined.

8. A process in accordance with claim 1, wherein the minimum distance of the bounding volumes is determined.

9. A process in accordance with claim 1, wherein the working space of the robots is divided into disjunct partial volumes and the information showing for which sentences each robot will occupy the particular partial volume is entered in an associated table for each partial volume.

10. A process in accordance with claim 9, wherein the working space of the robots is divided into disjunct cubes and that the information showing for which sentences each robot will occupy the particular cube is entered in an associated table for each cube.

11. A process in accordance with claim 1, wherein consecutive interlocks are merged with one another.

12. A process for protecting a multiaxial industrial robots from collision, the process comprising the steps:
automatically checking the programed movement process of a first industrial robot and the programed movement process of a second industrial robot for possible collisions; and
determining if interlocks are necessary and if so automatically inserting interlocks in each movement process.

13. A process in accordance with claim 12, wherein permissible interlock points are automatically determined before an interlock is inserted or before the check for possible collisions is carried out.

14. A process in accordance with claim 13, wherein each programed movement process includes sentences with sentence limits and sentence limits are determined as possible interlock points.

15. A process in accordance with claim 12, wherein bounding volumes of the robots or robot parts, which are checked for collisions, are generated for determining collisions.

16. A process in accordance with claim 15, wherein hierarchies of bounding volumes are generated.

17. A process in accordance with claim 12, wherein the intersection of the bounding volumes of at least two robots is determined.

18. A process in accordance with claim 12, wherein the minimum distance of the bounding volumes is determined.

19. A process in accordance with claim 14, wherein the working space of the robots is divided into disjunct partial volumes and the information showing for which sentences each robot will occupy the particular partial volume is entered in an associated table for each partial volume.

20. A process in accordance with claim 19, wherein the working space of the robots is divided into disjunct cubes and that the information showing for which sentences each robot will occupy the particular cube is entered in an associated table for each cube.
